(19) United States
(12) Patent Application Publication
(10) Pub. No.: US 2005/0170924 A1
(43) Pub. Date: Aug. 4, 2005

(54) Sprocket wheel for underground mining

(75) Inventors: Hans Meya, Werne (DE); Karl-Heinz Schurer, Herne (DE); Gerhard Merten, Lunen (DE); Wolfgang Kruger, Wuppertal (DE); Ludwig Brand, Washington, PA (US)

Correspondence Address: Steven M. Haas;Fay, Sharpe, Fagan, Minnich & McKee, LLP, Seventh Floor, 1100 Superior Avenue, Cleveland, OH, 44114-2518, US

(73) Assignee: DBT GmbH

(21) Appl. No.: 11/040,854

(22) Filed: Jan. 21, 2005

(30) Foreign Application Priority Data
Jan. 29, 2004 (DE) 10 2004 004 691.3

(51) Int. Cl. F16H 7/02; F16H 7/06

(52) U.S. Cl. 474/155; 474/153

(57) ABSTRACT

The invention relates to a sprocket wheel for underground mining, especially for chain-driven chain scraper conveyors, with a first ring 2 of first tooth elements 5 distributed uniformly about the circumference of the sprocket wheel body 1, at least one second ring 3 or 4, disposed axially offset to the first ring 2, having further tooth elements 6 or 7, distributed uniformly about the circumference. The flanks of the tooth elements that face one another are provided with pockets 13, that serve as contact surfaces for the horizontal chain links 9. In order to increase the service life of the sprocket wheel, the contact surfaces in the pockets 13 of each tooth element 5, 6, 7 comprise a wear inlay 20 of wear-resistant material.

The invention relates to a sprocket wheel for underground mining, especially for chain-driven chain scraper conveyors, plough systems and shearers with chains with vertical and horizontal chain links, with a first ring of first tooth elements distributed uniformly about the circumference of the sprocket wheel body and at least one second ring of second tooth elements, disposed axially offset to the first ring, distributed uniformly about the circumference of the sprocket wheel body, wherein the facing flanks of the tooth elements of the first ring and the second ring are provided with pockets that serve as contact surfaces for the outer surface of horizontal links of the chain and each contact surface includes at least one contact zone and at least one supporting zone for the chain links.

Chain-driven extraction, conveying and removal devices are especially used in underground coal mining for extraction and removal of the coal. All chain-driven mining devices comprise chains having horizontal (lying) and vertical (standing) chain links and running around two drive or return stations that are equipped with the drive components, wherein a sprocket wheel is disposed in a driveable manner at each drive or return station. Here, each sprocket wheel is matched to the geometry of the vertical and horizontal chain links to provide, with low wear, the best possible transmission of the drive forces into the circulating chain. Especially with chain scraper conveyors, where flight bar scrapers are attached to some of the horizontal chain links at defined intervals, the provision of the individual tooth elements with pockets serving as contact surfaces with the outer surfaces of the horizontal chain links has proven its worth in underground mining.

U.S. Pat. No. 4,850,942 discloses a sprocket wheel, the tooth elements of which are welded to the sprocket wheel body to provide a cheap sprocket wheel. At the same time, the danger of the formation of wear grooves on the tooth elements is to be reduced by oblique surfaces directed towards the interior of the wheel in the area of the transition between the rounding at the root of the tooth and the base of the pocket. The combination of the oblique surfaces and roundings with the teeth welded onto the sprocket base means that different pitches of identical teeth can be used on different sprockets, reducing storage costs.

GB 2 221 910 A discloses a sprocket wheel wherein each tooth element is configured as a double tooth, supporting the front end of a horizontal chain link with two pockets. The double teeth are bolted to the body of the sprocket wheel to allow replacement of the double teeth on the one hand and to allow the position of the double teeth to be adjusted to match different chain pitches on the other hand. In the event of damage due to wear, individual or all double teeth are exchanged. To effect a bolt-on connection, one embodiment of the sprocket wheel body is provided with recesses into which the shaft ends of the attachment bolts extend and in which lock-nuts can be disposed. Alternatively, rectangular indentations can be disposed on the outer circumference of the sprocket wheel body, into which rectangular intermediate media can be placed and attached by bolting, and to which the double teeth can then be bolted. The effort required to manufacture the sprocket wheel body is comparatively high.

Object of the invention is to provide a sprocket wheel that has a longer service life than the sprocket wheels of the prior art and that is also especially suitable for high-performance conveyors with high dimensional chains.

This object is solved, according to the invention, in that the contact zone and the supporting zone of each tooth element are composed of or consist of a wear inlay, or a plurality of wear inlays, of a material that is more wear-resistant than the material of the sprocket wheel body, wherein the wear inlays are attached to the tooth element body in an exchangeable manner. Here, the tooth element body forms that part of the tooth element that is diminuted about the wear inlay, so that the wear inlay is fixed to the tooth element body like an insert. The use of wear inlays on the highest-stressed zones of the pockets of the tooth elements, namely the supporting zone, on which a radial force component acts between the tooth element and the chain link, and on the contact zone, on which a tangential force component acts between the tooth element and the chain link, results in that wear on the contact zones of the sprocket wheel does not occur too rapidly and at the same time allows the sprocket wheel to support higher resultant forces. Such higher forces can especially occur with chain-driven high-performance conveyors whose chain links have a wire diameter of 48 mm and above.

In the preferred embodiment, the wear inlays only partially form the tooth head of the tooth element. In one embodiment, the wear inlay can form the entire surface of the pocket on one flank, i.e. the wear inlay extends over the entire surface of the pocket. This embodiment has the advantage that due to the wear inlays used in accordance with the invention, all potential contact surfaces in the pocket have greater strength and longer service life. With the especially-preferred embodiment, the wear inlay only partially forms the surface of the pocket on one flank. With this embodiment, advantageous support and attachment of the wear inlay to the tooth element body can be attained in a comparatively simple manner. In particular, the tooth element body may comprise at each pocket a recess with a recess flange circumferentially enclosing the recess, into which recess the wear inlay can be inserted. A wear inlay configured as an insertable part can therefore be inserted into the recess in which it is then supported immovably in all directions by means of the recess flange. It is especially advantageous if the wear inlay is anchored formlockingly and/or integrally in the recess, preferably by soldering or welding or glueing.

Each wear inlay can be configured as one piece and can completely extend over the contact zone and the supporting zone of a pocket of the tooth element. Alternatively, a plurality of wear inlays can be provided for each pocket, preferably two inlays, wherein the first wear inlay forms the contact zone and the second wear inlay forms the supporting zone. With this embodiment it is especially advantageous if both wear inlays are formed as flat wear inlay plates since then the wear inlays can be easily manufactured. In order to form the geometry of the pocket, the wear inlay plate that forms the contact zone can be configured substantially in the form of a triangle and the wear inlay plate that forms the supporting zone can be configured in the form of a polygon with two straight and one curved limiting edges. Here, it is especially advantageous if the wear inlay plates are provided with oblique surfaces on the limiting edges to avoid angular transitions that tend to break out.

In a further, alternative embodiment the wear inlays form the entire tooth head with all flanks and pockets. In this embodiment, the wear inlays that are configured as tooth heads can have at least one locking projection on their underside that engages form-lockingly in an associated engagement opening that is provided in a tooth element body configured as a tooth element stump on the sprocket wheel body. The locking projection and the engagement opening can have a cross-sectional profile that deviates from round cross-sections, so that a torsionally-rigid connection is provided between the tooth head and the tooth element body via the locking projection and the engagement opening. With this embodiment, it is especially advantageous if the wear inlay that is configured as a tooth head is provided with a welding chamfer or soldering chamfer on its edge on the transition to the underside.

With all embodiments, it is especially advantageous if the contact zone and the supporting zone include an angle of approximately 115° to 125°, preferably approximately 120.5°, between them. It is also preferable if the contact zone is configured descending obliquely towards the sprocket wheel body. The wear inlays can be made from numerous suitable materials. In a preferred embodiment, manganese hardened steel with a hardness of >65 HRC is used for the wear inlays.

The invention can be applied to all types of sprocket wheels used in underground mining. The invention's main field of application relates to sprocket wheels or chain drums for double mid chain scraper conveyors, wherein the chain drums then have three rings of tooth elements. The central ring has tooth elements configured as double teeth with four pockets and the two outer rings have tooth elements configured as single teeth with two pockets. Each horizontal chain link of the two adjacently-running chain strand then lies with its chain link front ends both in the pocket of a single tooth and in the pocket of a double tooth, wherein the vertical chain links reach through an intermediate space between the double tooth and the respective outer single tooth.

The invention will now be explained with reference to a plurality of embodiment examples of sprocket wheels according to the invention shown schematically in the drawings. In the drawings:

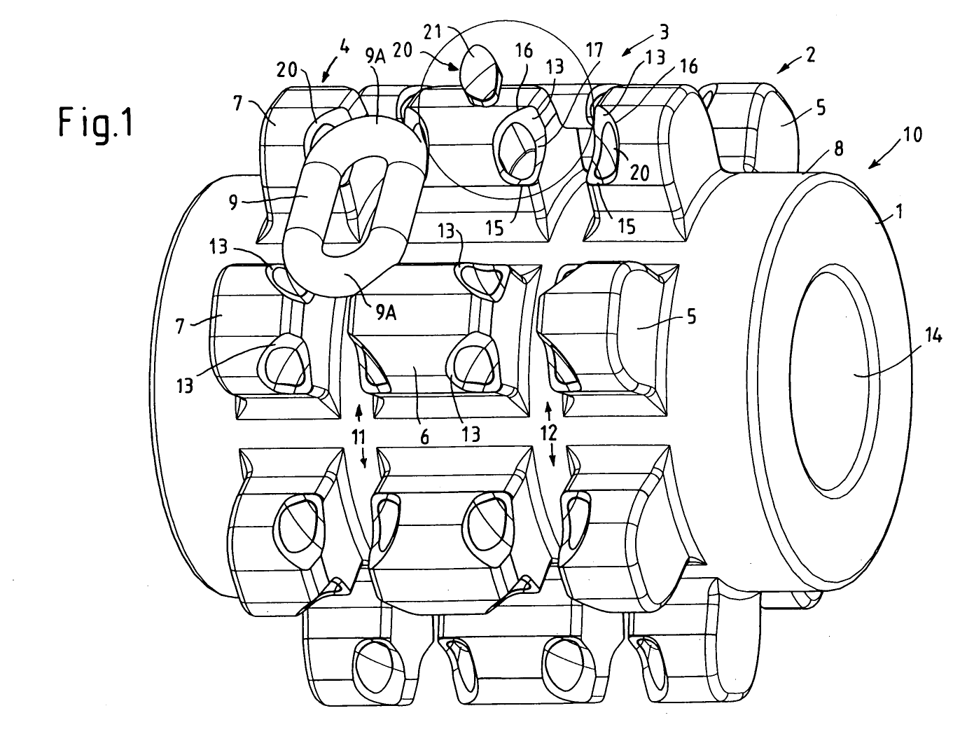

FIG. 1 is a schematic, perspective view of a sprocket wheel for a double mid chain scraper conveyor according to a first embodiment example;

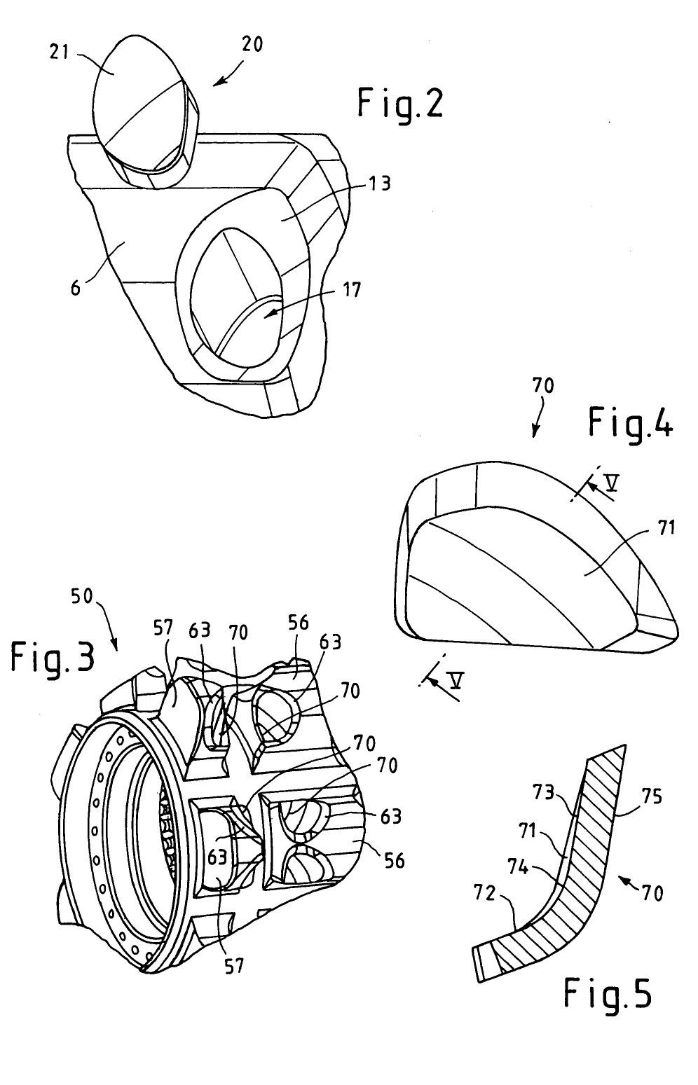

FIG. 2 is a detail elevation of FIG. 1, showing a pocket on the tooth head of a tooth element before insertion of a wear inlay;

FIG. 3 is a perspective view of a section of a sprocket wheel according to a second embodiment example;

FIG. 4 is a perspective elevation of the wear inlay used with the sprocket wheel according to FIG. 3;

FIG. 5 is a sectional elevation along the line V-V in FIG. 4;

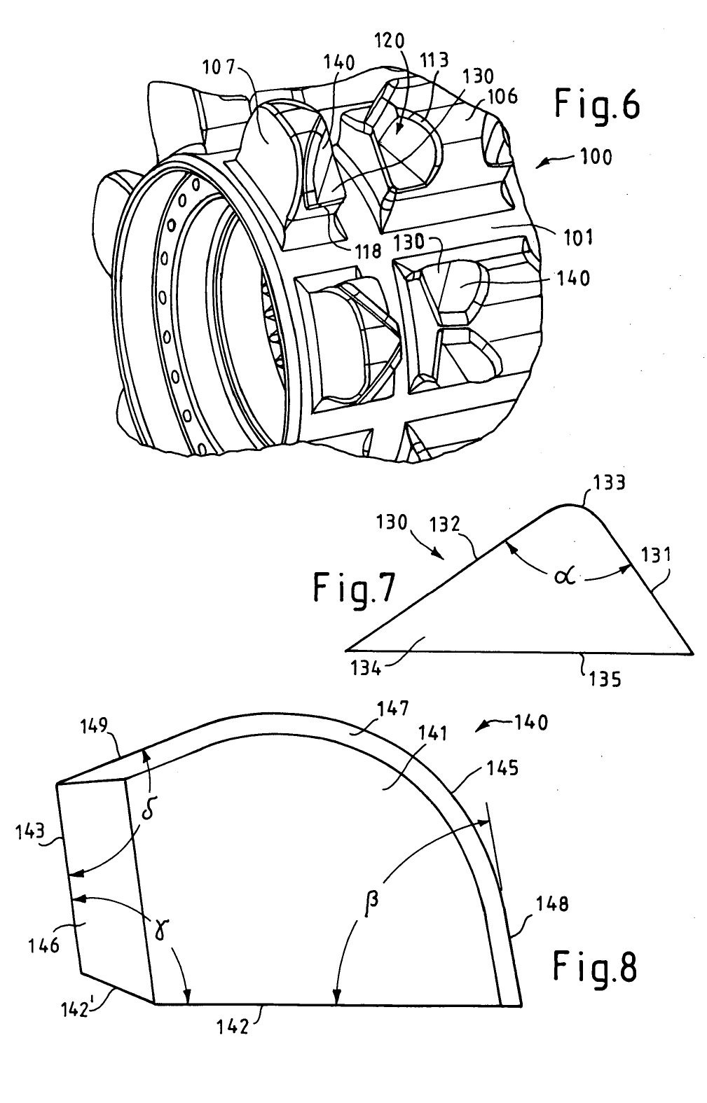

FIG. 6 is a perspective view of a section of a sprocket wheel according to a third embodiment example;

FIG. 7 is a detail elevation of the first wear inlay plate used with the sprocket wheel according to FIG. 6;

FIG. 8 is a top elevation of the second wear inlay plate used with the sprocket wheel according to FIG. 6;

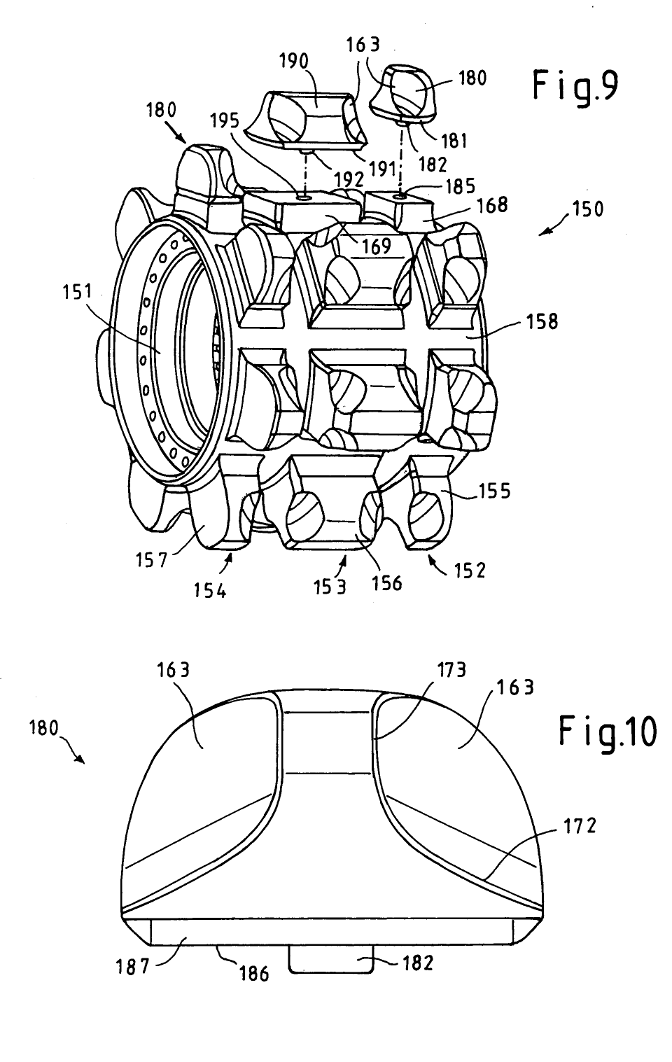

FIG. 9 is a perspective view of a sprocket wheel according to a fourth embodiment example; and

FIG. 10 is a side elevation of the single tooth used with the sprocket wheel according to FIG. 9.

In FIG. 1, reference number 10 denotes a sprocket wheel configured as a chain drum for a double mid chain scraper conveyor for underground mining. The sprocket wheel 10 comprises a sprocket wheel body 1 with three rings 2, 3, 4 of tooth elements 5, 6, 7 disposed axially offset to one another. Here, each ring 2, 3, 4 comprises a plurality of identically-structured tooth elements 5, 6 and 7, each disposed at a distance from one another and projecting from the external circumference 8 of the sprocket wheel body 1. All tooth elements 5, 7 of the two outer rings 2, 4 are configured as single tooth whilst the tooth elements 6 of the central ring 3 are configured as double teeth. A single horizontal chain link 9 of a chain of a double mid chain scraper conveyor, not shown in greater detail, is also shown in FIG. 1 in contact with the tooth elements 6, 7. It is known to the skilled person that in underground mining, each chain or each chain strand comprises a multitude of horizontal chain links 9 and vertical chain links that are disposed perpendicular to the horizontal chain links 9 and connect two horizontal chain links 9 with one another in a moveable manner.

The rings 2, 3, 4 with the tooth elements 5, 6, 7 are disposed so that the vertical chain links, not illustrated, reach through the intermediate space 11, 12 between the rings 3, 4 or 4, 5 without supporting themselves on the tooth elements 5, 6, 7. Contact between the chain links of the chain and the tooth elements 5, 6, 7 only actually takes place in the area of pockets 13 that are configured on the flanks of all tooth elements 5, 6, 7. Here, the tooth elements 5, 7 that are configured as single teeth each have two pockets 13, wherein a horizontal chain link 9 supports itself with a partial section of its front end 9A on each pocket 13. Whereas the tooth elements 6 of the central ring 3 are configured as double teeth and comprise a total of four pockets since the horizontal chain links 9 of both chain strands support themselves simultaneously on each tooth element (double tooth) 6. All pockets 13 on the flanks of the tooth elements 5, 6, 7 have the same structure and the same geometry, so the sprocket wheel 10 shown in FIG. 1 does not have a preferred running direction. It can also be seen from FIG. 1 that the respective pockets 13 on the individual tooth elements 5, 6, 7 are disposed in different directions, namely on the one hand in the direction of rotation and on the other hand counter to the direction of rotation, so that the front 9A of each horizontal chain link 9 is supported on a total of four tooth elements 6, 7 or 5, 6 of the sprocket wheel 10. Since the structure of all pockets 13 is otherwise identical, the following description is made by way of example for a pocket 13, irrespective of its alignment.

In the representation of the sprocket wheel 10 with only one illustrated horizontal chain link 9, the sprocket wheel 10 that can be supported via the central hub 14 about a drive or support shaft, not illustrated, rotates anti-clockwise. Here, all chain links 9 abut the rear pockets 13, in the running diretion, of tooth elements 6, 7 or 5, 6, whilst substantially no forces are acting in the circumferential direction on the front pockets 13, in the running direction. However, supporting forces in the radial direction are cting on and must be supported by the front. The force acting between the pockets 13 and the outer surface of the chain links 9 therefore contains on the one hand a radial force component that supports itself on the supporting zone that is located adjacent to the further inward-lying end 15 of the pocket, and a tangential force component that supports itself on a contact zone of the pocket 13, located adjacent to the outer end 16 of the pocket. The pockets 13 thus rise from the inner end 15 to the outer end 16 approximately in a bow or shell-shape, wherein the further inward-lying section of the pockets 13, disposed closer to the hub 14, drops slightly obliquely, whilst the section of the pocket that is disposed further outwards is aligned almost perpendicular to the circumference 8 of the sprocket wheel body 1.

In the embodiment example of the sprocket wheel 10 according to FIGS. 1 and 2, each pocket 13 is provided with a recess 17, having a closed recess flange, which recess 17 extends at least over those areas of the pocket 13 in which the contact zone and the supporting zone of the horizontal chain link 9 are disposed, therefore in which the front ends 9A of the horizontal (lying) chain links 9 directly abut the pockets 13 of the tooth elements 5, 6, 7 when the chain scraper conveyor is in operation. In accordance with the invention, a wear inlay 20 which is configured as one part, and with its surface 21 adapted to the geometry of the pocket 13, is placed in the recess 17, and in the installed state forms the surface of the pocket 13 at least in the area of the contact zone and the supporting zone for the rear and the forward front end 9A of the horizontal chain link 9.

FIG. 2 shows, in an enlarged elevation, the wear inlay 20 and the recess 17 in the pocket 13, for example of the tooth element 6 that is configured as a double tooth. Both the recess 17 and the wear inlay 20 have a substantially oval outer circumference so that the wear inlay 20 can be form-lockingly inserted into the recess 17 and can be glued, or especially soldered or welded, in place. In the installed state, the surface 21 of the wear inlay 20 can project slightly above the surface of the pocket 13, so that the horizontal chain link 9 can exclusively come into contact with the surface 21 of the wear inlay 20. Since the wear inlay 20 comprises a wear-resistant material such as especially manganese hardened steel, the hardness of which is substantially greater than the hardness of the sprocket wheel body or the tooth element body, i.e. that of the tooth element 6 that has the recess 17, all contact surfaces of the sprocket wheel 1 are more wear-resistant than is the case with hitherto common sprocket wheels. The service life of the sprocket wheel is therefore determined by the material composition and the service life of the wear inlay 20.

In the embodiment of a sprocket wheel 50 shown in FIG. 3, each tooth element 56, 57 is again provided on its flanks with pockets 63 on which the front ends of the horizontal chain links are supported. The four pockets 63 of the tooth elements 57, 56 that are necessary to support a horizontal chain link are all separately designated with a reference number 63. The entire surface of the pockets 63 of all four tooth elements 56, 57 is in each case formed by a wear inlay 70, which is shown in detail in FIGS. 4 and 5. The wear inlay 70, which can again preferably consist of manganese hardened steel, has a surface 71 that forms the pocket surface of the entire pocket 63, that is curved to match the surface geometry of the respective tooth elements 56, 57, and forms this. The surface 71 of the wear inlay 70, which forms the sole contact surface with the outer area of the horizontal chain link, comprises a lower section 72 and an upper section 73. The lower section 72 comprises, or forms, the supporting zone for the front end of the horizontal chain link and the upper section 73 of the wear inlay 70 forms the contact zone for the front end of the horizontal chain link. The driving forces introduced into the chain via the sprocket wheel 50 are therefore predominantly transmitted via the contact zone 73 whilst the tension in the chain is predominantly supported via the supporting zone in the lower section 72. The surface 71 of the wear inlay 70 is preferably shell-shaped, wherein the lower section 72 passes into the upper section 73 via a curved section 24 with a curve radius of, for example, approximately 25 mm. The angular deviation between the lower section 72 and the upper section 73, therefore between the supporting zone and the contact zone, is 120.5° in the illustrated embodiment example and the wear inlay 70 has a constant, uniform thickness of, for example, 13 mm. The underside 75 of the wear inlay 70 can be provided with comparatively simple, uniform, lenticular geometry so that the sprocket wheel body 51 (FIG. 3) or the tooth element body of each tooth element 56, 57 can also be provided with comparatively simple recesses, or slots or diminutions, preferably created during casting. Only the surface 71 of the wear inlay 70 receives the optimum surface geometry required for the respective chain links. In this way, manufacturing costs for the sprocket wheel body, preferably produced as a cast part, with the already formed-on tooth elements bodies, i.e. the tooth elements diminuted in that area that is subsequently formed by the wear inlay 70, can be reduced.

FIG. 6 shows a section of a sprocket wheel 100 according to a third embodiment example. With the sprocket wheel 100, the entire surface of the pockets 113 of the tooth elements 106 or 107 is again formed by wear inlays 120, however these are configured here in two parts and comprise a first wear inlay plate 130 and a second wear inlay plate 140. The two flat wear inlay plates 130 and 140 are shown in detail in FIGS. 7 and 8. The wear inlay plate 130 is substantially shaped like a right-angled triangle, i.e. the angle α between the two edge sides 131, 132 is 90°. Only the transition 133 between the two edge sides 131, 132 is rounded. As can be seen from FIG. 6, the wear inlay plate 130 is disposed on the tooth element body in such a way that it forms the supporting zone for the front end of the horizontal chain link, i.e. it is disposed and is attached, especially welded, glued or soldered, in a section 118 that falls away obliquely towards the sprocket wheel body 101. The surface 134 of the wear inlay plate 130 therefore lies slightly obliquely to the tangent on the cylindrical surface of the sprocket wheel body 101. The base edge 135 of the wear inlay plate 130 abuts the tooth element body, whilst the limiting edges 131, 132 lie free.

The wear inlay plate 140 shown in FIG. 8 is arranged on the tooth elements 106, 107 in such a way that in the installed state it comprises, or forms, the contact zone for the horizontal chain links. In the illustrated embodiment, the wear inlay plate 140 has a flat surface 141, wherein its polygonal basic shape is formed by two straight limiting edges 142, 143 and a curved limiting edge 145. The limiting edge 143 and the curved limiting edge 145 are each provided with bevels 146, 147. The curved limiting edge 145 is in each case provided with a straight edge section 148 or 149 on the transition to the connected, straight limiting edge 142, 143, wherein the edge section 148 with the limiting edge 142 includes an angle β of approximately 80°, and the limiting edge 143 with an edge section 149 includes an angle δ of approximately 103°. A short, obliquely extending transition section 142′ is provided between the two straight limiting edges 142, 143. In the installed state, the lower limiting edge 142 in FIG. 8 directly abuts the tooth element body, whilst the other edges 143, 145, 148, 149 are free.

FIG. 9 shows a fourth embodiment example of a sprocket wheel, designated in its entirety as 150, with three rings 152, 153 and 154 of tooth elements 155, 156, 157. These tooth elements 155, 156, 157 completely comprise wear-resistant material such as e.g. tooth heads 180, 190 formed from manganese hardened steel that are attached to tooth stumps 168 and 169, that are formed as components of the sprocket wheel body 151 around its circumference 158. The tooth head 180, that is suitable for forming either single tooth 155 and also single tooth 157 of the two outer rings 152, 154, comprises in each case two pockets 163 with a contact zone and a supporting zone for the front end of the horizontal chain links. The tooth head 190 which forms the double teeth of the central ring of teeth 153 correspondingly comprises a total of four pockets 163, wherein all pockets 163 have the same structure. The surface of the pockets 163 has a geometry that is optimised for interaction with the front ends of the horizontal chain links. The tooth heads 180, 190 can be produced as cast parts from wear-resistant material such as in particular manganese hardened steel. A locking projection 182, 192 is formed on the under-side 181, 191 of both tooth bodies 180 and 190 in order to be able to anchor the tooth heads 180, 190 with the tooth stumps 168, 169 on the sprocket wheel body 151. The locking projection 182, 192 engage in an associated engagement recess 185, 195 in the flat upper side of the sprocket wheel stump 168, 169. The locking projection 182 of the tooth head 180 is best seen in FIG. 10. The locking projection 182 can have a cross-section that allows torsionally secure attachment of the tooth head 180 in the associated tooth element stump. The underside 186 of the tooth element head 180 is flat with the exception of the locking projection 182, wherein welding chamfers or soldering chamfers 187 are formed on the edge at the transition to the underside 186 to solidly connect the tooth head 180 with the tooth element stump by welding or soldering. Furthermore, FIG. 10 shows that the lower section 172 of the surface of the pockets 163 includes an angle of approximately 120° with the upper section 173 and falls obliquely downwards, resulting in favourable, low-wear engagement behaviour of the chain links in the pockets.

1. A sprocket wheel for underground mining, especially for chain-driven chain scraper conveyors, plough systems and shearers with chains having vertical and lying chain links, the wheel comprising a first ring of first tooth elements distributed uniformly about the circumference of the sprocket wheel body and at least one second ring of second tooth elements, disposed axially offset to the first ring and distributed uniformly about the circumference, the tooth elements comprising flanks and the facing flanks of the tooth elements of the first ring and the second ring are provided with pockets serving as contact surfaces for the outer surface of horizontal links of the chain and each contact surface includes at least one contact zone and one supporting zone, where the supporting zone and the contact zone of each tooth element are composed of a wear inlay or a plurality of wear inlays of a material that is more wear-resistant than the material of the sprocket wheel body, which inlays are exchangeable attached to a tooth element body of the tooth element.

2. A sprocket wheel according to claim 1, wherein the wear inlays only partially form the tooth head of the tooth element.

3. A sprocket wheel according to claim 1, wherein the wear inlay forms the entire surface of the pocket on one flank.

4. A sprocket wheel according to claim 1, wherein the wear inlay only partially forms the surface of the pocket on one flank.

5. A sprocket wheel according to claim 1, where on each pocket, the tooth element body has a recess with a closed recess flange, in which recess the wear inlay can be inserted.

6. A sprocket wheel according to claim 5, wherein the wear inlay is form-lockingly or integrally anchored in the recess, preferably by soldering or welding or glueing.

7. A sprocket wheel according to claim 6, wherein the recess in the tooth element body is substantially oval.

8. A sprocket wheel according to claim 1, wherein each wear inlay is configured as one part and completely extends over the supporting zone and the contact zone of a pocket of the tooth element.

9. A sprocket wheel according to claim 1, wherein two wear inlays are provided for each pocket, wherein the first wear inlay forms the supporting zone and the second wear inlay forms the contact zone.

10. A sprocket wheel according to claim 9, wherein both wear inlays are configured as flat wear inlay plates.

11. A sprocket wheel according to claim 10, wherein the wear inlay plate that forms the supporting zone is substantially triangular and that the wear inlay plate that forms the contact zone is polygonal with two straight limiting edges and a curved limiting edge.

12. A sprocket wheel according to claim 1, wherein the wear inlays form the entire tooth head with all flanks and pockets.

13. A sprocket wheel according to claim 12, wherein the wear inlay being configured as a tooth head has at least one locking projection on its lower side that engages in an associated engagement opening, provided in a tooth element body configured as a tooth element stump on the sprocket wheel body.

14. A sprocket wheel according to claim 12, wherein the wear inlay configured as a tooth head is provided with a welding or soldering chamfer on the transition to the underside.

15. A sprocket wheel according to claim 1, wherein the contact zone and the supporting zone include an angle of approximately 115° to 125°, preferably approximately 120.5°, between themselves.

16. A sprocket wheel according to claim 15, wherein the supporting zone is aligned to drop obliquely towards the sprocket wheel body.

17. A sprocket wheel according to claim 1, wherein the wear inlay consists of or comprises manganese hardened steel.

18. A sprocket wheel according to claim 1, wherein the sprocket wheel is configured as a chain drum for a double mid chain scraper conveyor and has three rings of tooth elements, wherein the central ring of tooth elements comprises double teeth each having four pockets and the two outer rings of tooth elements comprise single teeth having two pockets.

19. A sprocket wheel according to claim 2, wherein the wear inlay forms the entire surface of the pocket on one flank.

20. A sprocket wheel according to claim 2, wherein the wear inlay only partially forms the surface of the pocket on one flank.
